(19) United States
(12) Patent Application Publication
(10) Pub. No.: US 2015/0178896 A1
(43) Pub. Date: Jun. 25, 2015

(54) IMAGE PROCESSING AND ENHANCEMENT METHODS AND ASSOCIATED DISPLAY SYSTEMS

(71) Applicant: Zhigang Fan, Webster, NY (US)

(72) Inventor: Zhigang Fan, Webster, NY (US)

(21) Appl. No.: 14/575,245

(22) Filed: Dec. 18, 2014

Related U.S. Application Data
(60) Provisional application No. 61/919,041, filed on Dec. 20, 2013.

(51) Int. Cl. G06T 5/00; G06K 9/62

(52) U.S. Cl. CPC G06T 5/00; G06K 9/6267; G09G 2330/021

(57) ABSTRACT

A method, and a display system for enhancing and processing images for display based on a set of context information. A plurality sets of pixel values representing an image are received. A set of image context classifications are determined, a plurality of user settings are received. An ambient light level is received. Said image is processed and enhanced in accordance to said image context classification, said user settings and/or said ambient light level. Said enhanced image is displayed.

### CROSS-REFERENCE TO RELATED APPLICATION

This application hereby claims priority under 35 U.S.C. §119 to U.S. Provisional Patent Application No. 61/919,041 filed Dec. 20, 2013, entitled “IMAGE PROCESSING AND ENHANCEMENT METHODS AND ASSOCIATED DISPLAY SYSTEMS,” the disclosure of which is incorporated herein by reference.

### TECHNICAL FIELD

Embodiments are generally related to image display systems and image processing and enhancement methods for display images.

### BACKGROUND OF THE INVENTION

Flat-panel display systems are wildly used in portable electronic devices, such as multi-function smart phones, digital media players, and dedicated digital cameras and navigation devices. The display systems generate image/video by emitting, or modulating light on an array of pixels. This includes devices creating various colors via interference of reflected light, such as Interferometric modulator display (IMOD, trademarked mirasol) technology. The attributes for measuring display image quality often include color fidelity, contrast, brightness, saturation, detail rendition, and free of noticeable artifacts. For portable devices, the image quality needs to be measured for different operation conditions, in particular, under various illumination conditions. In additional to image quality, the power consumption is another important design factor needs to be taken into consideration. This is due to the fact that the portable devices must be capable of operating only on an internal battery. The battery must be small to keep the device weight low. Some portable devices are designed to have a “power saving” mode. Less battery power is consumed when the mode is activated. The screen brightness is typically reduced in power saving mode to save battery consumption. As a form of power saving mode, in some devices, a screen brightness setting is provided, by which, a user may adjust the screen brightness for balancing the tradeoff between the image quality and power consumption.

Different attributes for a flat-panel display system often pose conflicting demands in system design. For example, an increased contrast often implies more power consumption. A higher brightness level may reduce color saturation. As a result, tradeoffs are essential in balancing different needs. Yet, for images/videos of different contents, and/or of different viewing conditions, the tradeoffs could be very different. For example, displaying a document image under the sunlight, readability and hence boosting contrast would be at a much higher priority than say color saturation. On the other hand, displaying a color scenery photo in a room with a dim light, the contrast and saturation would be treated in a more balanced manner. It is also well known that different image contents have different sensitivities to different kinds of artifacts and distortions.

Thus, there is need for devices, methods, and a computer readable medium for intelligently selecting image enhancement and processing algorithms and parameters that are optimized for different context, which includes the image/video content, illumination conditions, and user intention inputs (e.g. power saving mode setting).

### INCORPORATION BY REFERENCE

U.S. Pat. No. 4,670,780, issued Jun. 2, 1987, by McManus et al, entitled “Method of matching hardcopy colors to video display colors in which unreachable video display colors are converted into reachable hardcopy colors in a mixture-single-white (MSW) color space”

U.S. Pat. No. 4,751,535, issued Jun. 14, 1988, by Myers et al., entitled “Color-matched printing”;

U.S. Pat. No. 4,839,721, issued Jun. 13, 1989, by Abdulwahab et al., entitled “Method of and apparatus for transforming color image data on the basis of an isotropic and uniform colorimetric space”;

U.S. Pat. No. 4,941,038, issued Jul. 10, 1990, by Walowit, entitled “Method for color image processing”;

U.S. Pat. No. 5,185,661, issued Feb. 9, 1993, by Ng, entitled “Input scanner color mapping and input/output color gamut transformation”;

U.S. Pat. No. 5,483,259, issued Jan. 9, 1996, by Sachs, entitled “Color calibration of display devices”;

U.S. Pat. No. 5,638,117, issued Jun. 10, 1997, by Engeldrum et al, entitled “Interactive method and system for color characterization and calibration of display device”;

U.S. Pat. No. 5,956,468, issued Sep. 21, 1999, by Ancin, entitled “Document segmentation system”;

U.S. Pat. No. 6,094,205, issued Jul. 25, 2000, by Jaspers, entitled “Sharpness control”;

U.S. Pat. No. 6,850,642, issued Feb. 1, 2005, by Wang, entitled “Dynamic histogram equalization for high dynamic range images”;

U.S. Pat. No. 6,973,213, issued Dec. 6, 2005, by Fan et al., entitled “Background-Based Image Segmentation”;

U.S. Pat. No. 6,985,628, issued Jan. 10, 2006, by Fan, entitled “Image Type Classification Using Edge Features”;

U.S. Pat. No. 6,996,277, issued Feb. 7, 2006, by Fan, entitled “Image type classification using color discreteness features”;

U.S. Pat. No. 7,042,520, issued May 9, 2006, by Kim, entitled “Method for color saturation adjustment with saturation limitation”;

U.S. Pat. No. 7,193,659, issued Mar. 20, 2007, by Huang et al., entitled “Method and apparatus for compensating for chrominance saturation”;

U.S. Pat. No. 7,406,208, issued Jul. 29, 2008, by Chiang, entitled “Edge enhancement process and system”;

U.S. Pat. No. 7,443,453, issued Oct. 28, 2008, by Hsu et al., entitled “Dynamic image saturation enhancement apparatus”;

U.S. Pat. No. 7,538,917, issued May 26, 2009, by Rich et al., entitled “Method for prepress-time color match verification and correction”;

U.S. Pat. No. 7,636,496, issued Dec. 22, 2009, by Duan et al., entitled “Histogram adjustment for high dynamic range image mapping”;

U.S. Pat. No. 8,139,890, issued Mar. 20, 2012, by Huang, entitled “System for applying multi-direction and multi-slope region detection to image edge enhancement”;

U.S. Pat. No. 8,639,056, issued Jan. 28, 2014, by Zhai et al, entitled “Contrast enhancement”;

U.S. Pat. No. 8,761,537, issued Jun. 24, 2014, by Wallace, entitled “Adaptive edge enhancement”;

U.S. Pat. No. 8,810,876, issued Aug. 19, 2014, by Koehl et al., entitled “Dynamic image gamut compression by performing chroma compression while keeping lightness and hue angle constant”.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, an aspect of the disclosed embodiments to provide for an improved image enhancement and processing method and system including the use of context information for achieving a better image quality.

The aforementioned aspects and other objectives and advantages can now be achieved as described herein. A method, and a display system for enhancing and processing image data for color display, comprising:
receiving a plurality sets of pixel values representing an image;
determining a set of image context classifications;
receiving a plurality of user settings;
receiving an ambient light level;
enhancing and processing said image in accordance to said image context classifications, said user settings and/or said ambient light level; and
displaying said image.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of a portable electronic system;

FIG. 2 illustrates a high-level flow chart depicting a method in accordance with an embodiment of a present teachings.

FIG. 3 illustrates a graph depicting a flow chart depicting an embodiment of image context generation of a present teachings;

FIG. 4 illustrates a graph depicting a flow chart depicting an embodiment of context based image enhancement and processing of a present teachings;

FIG. 5 illustrates a graph depicting a flow chart depicting an embodiment of context dependent tone adjustment of a present teachings;

### DETAILED DESCRIPTION

This disclosure pertains to systems, methods, and a computer readable for enhancing and processing an image for display based on context information. While this disclosure discusses a new technique for display for portable electronic devices, one of ordinary skill in the art would recognize that the techniques disclosed may also be applied to other contexts and applications as well.

The particular values and configurations discussed in these non-limiting examples can be varied and are cited merely to illustrate at least one embodiment and are not intended to limit the scope thereof.

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

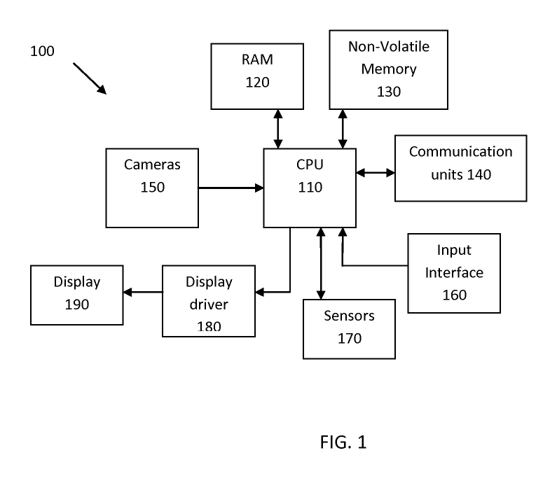

Referring now to FIG. 1, a block diagram of a portable electronic system used to illustrate an example embodiment in which several aspects of the present invention may be implemented. Portable electronic device 100 is shown containing central processing unit (CPU) 110, RAM 120, non-volatile memory 130, communication units 140, cameras 150, input interface 160, sensors 170 (including Ambient light sensor (ALS)), and display driver 180 driving display 190. Only the components as pertinent to an understanding of the operation of the example embodiment are included and described, for conciseness and ease of understanding.

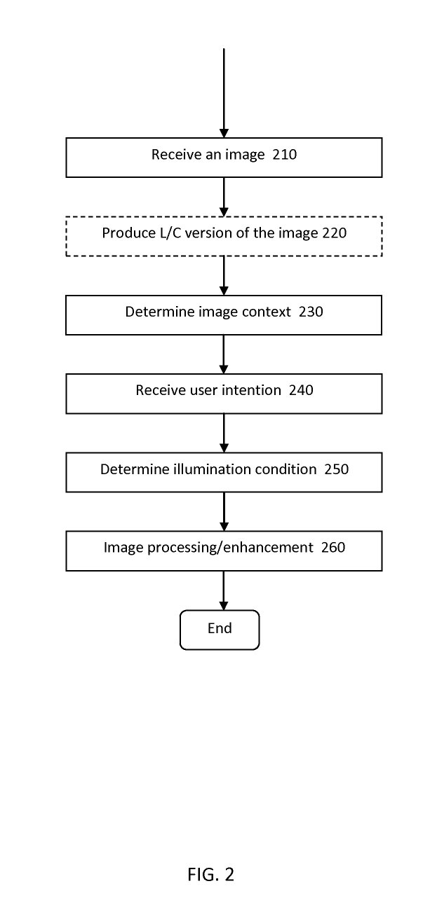

Referring now to FIG. 2, a flow chart depicting a method in accordance with an embodiment of a present teachings. In block 210, a bitmap image to be displayed is received. The image is typically in an RGB color space. It may also contain additional rendering hints and tagging information associated with the bitmap. The tagging information may include the object information associated with each pixel in the bitmap. Block 220 represents an optional step. A luminance/chrominance version of the input image (such as in Ycbcr and L*a*b* spaces) is generated. The luminance/chrominance space data are often useful for the operations in some of the later steps. It will be used together with the RGB data as the inputs to the later modules. In block 230, the image context information is generated. The image context information may include but not limited to image classification, object classification, and temporal classification. The image can be classified according to its content as text, synthetic graphics, natural pictures, maps, mixed, etc. A “mixed” class refers to images that contain more than one kind of objects, for example, an image with both synthetic graphics and natural pictures. The image can also be classified according to its tone-type as black and white, multiple tone (color) and continuous tone (color). A multiple tone (color) image contains multiple well separated colors, and the number of colors are quite limited (e.g. <20), as often seen in synthetic graphics. A continuous tone (color) image, typically seen in natural pictures, contains a large number of colors, and many of which are adjacent to each other in the color space. The pixels within an image can be further grouped into objects, such as a text character, a rectangle box. These objects can also be classified into a few categories, such as text characters, background, details (lines and curves), graphical objects (such as rectangles and circles), and pictures. The temporal classification provides temporal dynamics of the current image in terms of its relationship with the previously displayed images. It can be classified as a still image (zero change), a (temporally) slowly changing image, a (temporally) fast changing image, or a scene cut, based on the amount and rate of changes.

In blocks 240 and 250, other context information (user intention and illumination condition) are extracted, respectively. The user intention may include various user settings and mode selections that are related to display, for example, power saving mode including screen brightness settings. The illuminant condition refers to the detected current level of visible light in the immediate environment. It can be read from an ambient light sensor (ALS) in the sensor unit 170.

In block 260, the input image is processed/enhanced based on the context information. The operations included but not limited to tone adjustment, edge/detail enhancement, and gamut mapping.

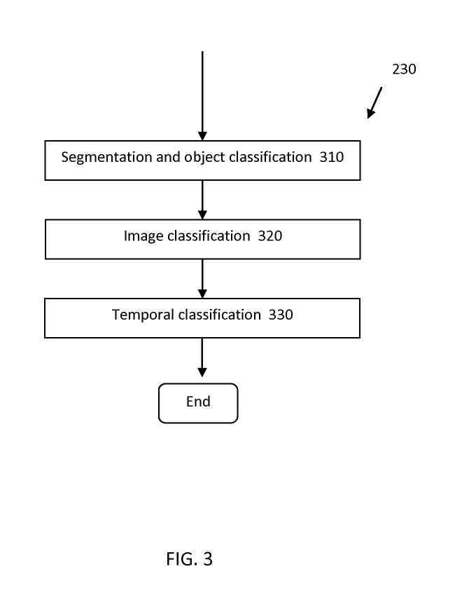

Referring now to FIG. 3, a flow chart depicting an embodiment of image context generation in accordance with an embodiment of a present teachings. In block 310, the input image is segmented into objects and the objects are classified. This can be accomplished by many known methods, for example, the method disclosed in US patent of Fan, “Background-Based Image Segmentation”, disclosed in U.S. Pat. No. 6,973,213, the contents of which is incorporated herein by reference, the method disclosed in US patent of Ancin, “Document segmentation system”, disclosed in U.S. Pat. No. 5,956,468, the contents of which is incorporated herein by reference, the method disclosed in US patent of Fan, “Image Type Classification Using Edge Features”, disclosed in U.S. Pat. No. 6,985,628, the contents of which is incorporated herein by reference, and the method disclosed in US patent of Fan, “Image type classification using color discreteness features”, disclosed in U.S. Pat. No. 6,996,277, the contents of which is incorporated herein by reference. The object information may also be obtained from the tagging information received associated with the input bitmap. In block 320, the input image is classified. The text/graphics/picture classification can be performed combining the object classification results. An image contains only text characters and backgrounds are a text image. An image contains text and graphical objects are a graphics image. An image contains mainly pictures is a pictorial images. It is a mixed image if it contains both graphical or text objects together with pictures. The image can further classified as black and white, multiple tone, and continuous tone, by examine the number of distinct colors contained in the image. In block 330, temporal classification is performed. The current image is compared to the previous displayed image(s). If no changes are detected, the classification is “still”. Otherwise, it is classified as “slowly changing”, “fast changing” and “scene cut”, depending on the amount of changes detected. For saving storage and computation, the comparison may also be performed on the histograms, or other features of the images, such as means, variances, medians of the images, instead of image bitmaps themselves.

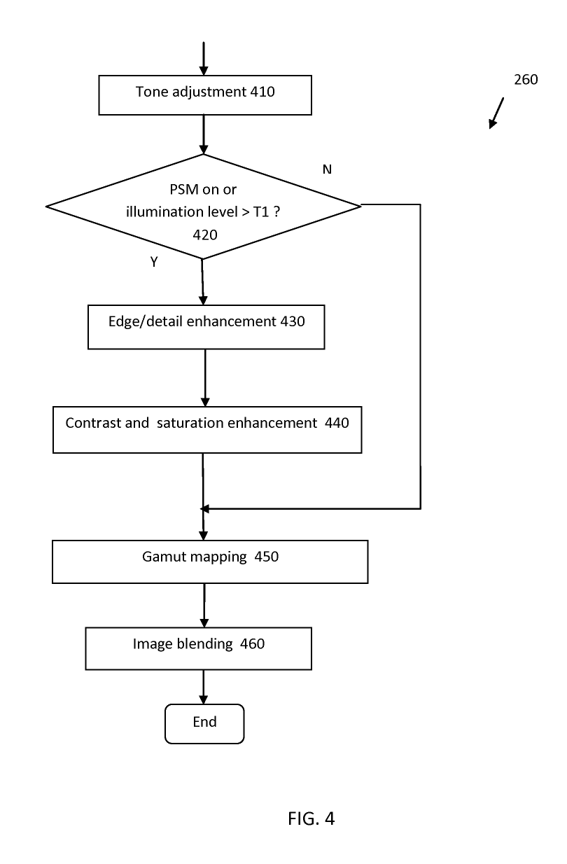

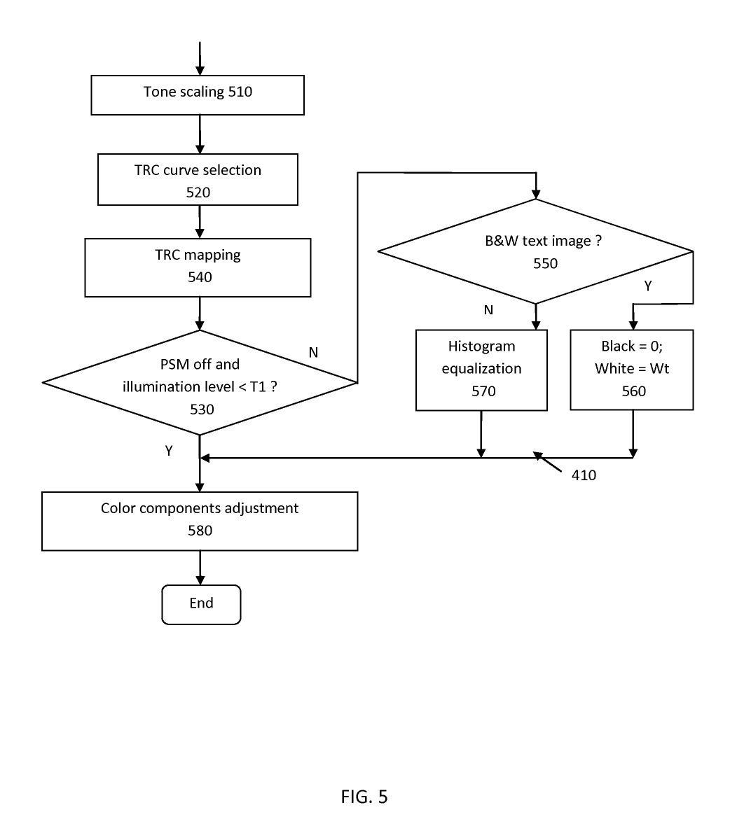

Referring now to FIG. 4, a flow chart depicting an embodiment of context dependent image enhancement and processing in accordance with an embodiment of a present teachings. In block 410, the luminance component of the image is first adjusted, based on the illumination conditions, power saving mode and image classification. The procedure will be further described in detail later in FIG. 5. In block 420, it is checked to see if the power saving mode is on, or the ambient light level is above a predetermined threshold T1. If the answer is Yes in block 420, edges and details of the image are enhanced in block 430, and contrast and saturation are enhanced in block 440. The edge/detail enhancement can be performed by many known methods, for example by a high-pass filter, or by the method disclosed in US patent of Chiang, “Edge enhancement process and system”, disclosed in U.S. Pat. No. 7,406,208, the contents of which is incorporated herein by reference, the method disclosed in US patent of Jaspers, “Sharpness control”, disclosed in U.S. Pat. No. 6,094,205, the contents of which is incorporated herein by reference, the method disclosed in US patent of Huang, “System for applying multi-direction and multi-slope region detection to image edge enhancement”, disclosed in U.S. Pat. No. 8,139,890, the contents of which is incorporated herein by reference, or the method disclosed in US patent of Wallace, “Adaptive edge enhancement”, disclosed in U.S. Pat. No. 8,761,537, the contents of which is incorporated herein by reference. The amount of enhancement may vary for different types of objects in the image. It could be more aggressive for text characters, and less so for graphical components, and even less so for pictures.

In block 440, the saturation of the image is enhanced. This can be again, performed with many known methods, for example, the method disclosed in US patent of Kim, “Method for color saturation adjustment with saturation limitation”, disclosed in U.S. Pat. No. 7,042,520, the contents of which is incorporated herein by reference, and the method disclosed in US patent of Hsu et al., “Dynamic image saturation enhancement apparatus”, disclosed in U.S. Pat. No. 7,443,453, the contents of which is incorporated herein by reference.

A gamut mapping is performed in block 450. A set of gamuts are measured offline for the display under various illumination condition and power mode settings, and are stored. A gamut is selected in accordance with the current illumination condition and power mode setting. The gamut mapping is then performed. This can be achieved with many known procedures, for instance, the method disclosed in US patent of McManus et al., “Method of matching hardcopy colors to video display colors in which unreachable video display colors are converted into reachable hardcopy colors in a mixture-single-white (MSW) color space”, disclosed in U.S. Pat. No. 4,670,780, the contents of which is incorporated herein by reference, the method disclosed in US patent of Myers., “ Color-matched printing”, disclosed in U.S. Pat. No. 4,751,535, the contents of which is incorporated herein by reference, the method disclosed in US patent of Abdulwahab et al, “Method of and apparatus for transforming color image data on the basis of an isotropic and uniform colorimetric space”, disclosed in U.S. Pat. No. 4,839,721, the contents of which is incorporated herein by reference, the method disclosed in US patent of Walowit, “Method for color image processing”, disclosed in U.S. Pat. No. 4,941,038, the contents of which is incorporated herein by reference, and the method disclosed in US patent of Ng, “Input scanner color mapping and input/output color gamut transformation”, disclosed in U.S. Pat. No. 5,185,661, the contents of which is incorporated herein by reference. The procedure may further include a step for selecting a gamut mapping algorithm and/or associated parameters that are optimized for the current image content classification. Many known selection methods can be applied here, for example, the method disclosed in US patent of Rich et al., “Method for prepress-time color match verification and correction”, disclosed in U.S. Pat. No. 7,538,917, the contents of which is incorporated herein by reference, and the method disclosed in US patent of Koehl et al., “Dynamic image gamut compression by performing chroma compression while keeping lightness and hue angle constant”, disclosed in U.S. Pat. No. 8,810,876, the contents of which is incorporated herein by reference. In one embodiment of the present invention, an algorithm with an emphasis on contrast and with a hard clipping is selected for the text images (or the text regions of the images). For graphics images (or the graphical objects in the images), an algorithm with an emphasis on saturation and with a hard clipping is selected. For pictorial images (or the pictorial regions of the images), the algorithm with perceptual or relative colorimetric intents and with a soft clipping is selected.

The enhanced/processed image obtained through steps 410 to 450 is optimized based on the current input image, without considering the previously displayed images. To prevent the artifacts caused by a sudden change in image appearances, the enhanced/processed image is blended with a “nominal” image in block 460. The nominal image is generated by enhancing/processing the current input image with the enhancement/processing parameters used in the previous image. In one embodiment of present invention, the blending is performed as:

result image=α×enhanced image+(1−α)×nominal image

where α is a blending factor in the range of [0, 1]. The blending factor is determined based on the image temporal classification, power saving mode setting and illumination condition changes. A greater α (close to 1) is selected if there is a change in power saving mode setting, a sudden change in illumination, or a scene cut or fast changing in temporal classification. A small α (close to 0) is selected if there is no change in power saving mode setting, illumination remains constant, and a still image or slowly changing in temporal classification.

Referring now to FIG. 5, a flow chart depicting an embodiment of context dependent tone adjustment in accordance with an embodiment of a present teachings. A tone scaling factor is first determined in block 510 and the luminance component of the pixels in the input image are multiplied by the tone scaling factor. The scaling factor is designed offline for different illumination conditions, image content, and power saving mode settings, base on both image quality and power consumption considerations. Generally speaking, a greater factor is applied for a higher illumination level. For the same illumination condition, a smaller factor will be used if the power saving mode is on. The factor may also vary with the image content classification. In one embodiment of the present invention, the factor is set in the order of: text>=graphics>=picture for high illumination cases. In another embodiment of the present invention, the factor is set in the order of: black and white>=multiple tone>=continuous tone picture for high illumination cases.

In block 520, a TRC (Tone Reproduction Curve) that is linearized under the current illumination condition is obtained in accordance with the ALS reading. The TRC curves are calibrated offline that are optimized under various illumination conditions. This can be accomplished by numerous known calibration methods. for instance, the method disclosed in US patent of Engeldrum et al., “Interactive method and system for color characterization and calibration of display device”, disclosed in U.S. Pat. No. 5,638,117, the contents of which is incorporated herein by reference, and the method disclosed in US patent of Sachs, “Color calibration of display devices”, disclosed in U.S. Pat. No. 5,483,259, the contents of which is incorporated herein by reference. The luminance component of the image is tone-mapped with the selected TRC in block 530.

Two conditions are examined in the next step (block 540): 1) if the power saving mode is off; 2) if the illumination level is below a predetermined threshold T2. If at least one of the conditions are not met (No in block 540), the image is processed depending on whether it is a black and white text image (block 550). For a black and white text image (Yes in block 550), the luminance of the black pixels in the input image is set to 0, if it is not already so, and the luminance of the white pixels in the input image is set to a predetermined value Wt (block 560). The value of Wt may vary for different illumination conditions and power saving mode settings. For an image that is not black and white text (No in block 550), a histogram equalization or other tone enhancement algorithm, for example, the method disclosed in US patent of Zhai et al., “Contrast enhancement”, disclosed in U.S. Pat. No. 8,639,056, the contents of which is incorporated herein by reference, the method disclosed in US patent of Wang, “Dynamic histogram equalization for high dynamic range images”, disclosed in U.S. Pat. No. 6,850,642, the contents of which is incorporated herein by reference, and the method disclosed in US patent of Duan et al., “Histogram adjustment for high dynamic range image mapping”, disclosed in U.S. Pat. No. 7,636,496, the contents of which is incorporated herein by reference, is performed in block 570 for the luminance component of the image. The tone enhancement could be global or local. The amount for enhancement may depend on the context information, including image classification, power saving mode setting and illumination conditions. The two chrominance components of the image are adjusted if necessary, to keep the original hue and saturation unchanged (block 580). This can be achieved with many known procedures, for instance, the method disclosed in US patent of Huang et al., “Method and apparatus for compensating for chrominance saturation”, disclosed in U.S. Pat. No. 7,193,659, the contents of which is incorporated herein by reference.

It will be appreciated that variations of the above-disclosed and other features and functions, or alternatives thereof, may be desirably combined into many other different systems or applications.

To prevent sudden image appearances change, one variation of present invention is applying constraints on enhancement/processing parameter changes, instead of image blending as described in block 460. The constraints are based on the image temporal classification, power saving mode setting and illumination condition changes. More changes (in comparison to the parameters used in the previous image) are allowed if there is a change in power saving mode setting, a sudden change in illumination, or a scene cut in temporal classification. Less changes are allowed if there is no change in power saving mode setting, illumination remains constant, and a still image or slowly changing in temporal classification.

Another variation is applying soft decisions, or feature extraction instead hard decisions in classification. For example in temporal classification, instead of classification with four distinct categories of still image, slowly changing, fast changing and scene cut, a temporal changing rate feature can be extracted and later applied in determining the amount of blending.

Also that various presently unforeseen or unanticipated alternatives, modifications, variations or improvements therein may be subsequently made by those skilled in the art which are also intended to be encompassed by the following claims.

1. A method for enhancing and processing image data for a color display system, the method comprising:
receiving a plurality sets of pixel values representing an image;
determining a set of image context classifications;
receiving a plurality of user settings;
receiving an ambient light level;
enhancing and processing said image in accordance to said image context classifications, said user settings and/or said ambient light level; and
displaying said enhanced image.

2. The method of claim 1, wherein said determining a set of image context classifications further comprise:
classifying said image into a content category and/or a tone-type category;
segmenting said image into a plurality of objects and classifying said objects; and/or
classifying said image in terms of its relative changes with a plurality of previously displayed images.

3. The method of claim 1, wherein said enhancing and processing image further comprises:
tone adjustment;
edge and detail enhancement;
saturation enhancement; and/or
gamut mapping.

4. The method of claim 1, wherein said user settings further comprise:
power saving mode settings;
screen brightness settings.

5. A display system comprising:
an image receiving module receiving a plurality sets of pixel values representing an image;
an image classifier determining a set of image context classifications;
a user setting module receiving a plurality of user settings;
an ambient light level module receiving an ambient light level; and
an image enhancing and processing module enhancing and processing said image in accordance to said image context classifications, said user settings and said ambient light level; and
a display panel displaying said enhanced image.

6. The system of claim 5, wherein said determining a set of image context classifications further comprise:
classifying said image into a content category and/or a tone-type category;
segmenting said image into a plurality of objects and classifying said objects; and/or
classifying said image in terms of its relative changes with a plurality of previously displayed images.

7. The system of claim 5, wherein said enhancing and processing image further comprises:
tone adjustment;
edge and detail enhancement;
saturation enhancement; and/or gamut mapping.

8. The system of claim 5, wherein said user settings further comprise:
power saving mode settings;
screen brightness settings.
